(19) United States
(12) Patent Application Publication
(10) Pub. No.: US 2025/0319564 A1
(43) Pub. Date: Oct. 16, 2025

(54) SENSORLESS TOOL HEALTH MONITORING

(71) Applicant: FANUC CORPORATION, Yamanashi (JP)

(72) Inventors: Yen Po Liu, Union City, CA (US); Tetsuaki Kato, Fremont, CA (US)

(21) Appl. No.: 18/636,363

(22) Filed: Apr. 16, 2024

(51) Int. Cl. B23Q 17/09; G05B 19/4065

(52) U.S. Cl. CPC B23Q 17/0957; G05B 19/4065; B23Q 2717/006; G05B 2219/50185

(57) ABSTRACT

A sensorless method for cutting tool health monitoring which continuously evaluates the health of a cutting tool and requires no sensors to be added to the machine tool. During a machine tool cutting operation, time series data for one or more machine tool parameter such as spindle torque or servo motor velocity is collected and converted to the frequency domain. The magnitude of the data at the spindle frequency is divided by the magnitude of a reference data set for the same parameter at the spindle frequency, where the ratio is designated as a tool breakage indicator. The tool breakage indicator is monitored over time to identify any increase in value, and its value is also compared to predefined thresholds. Various criteria may be defined which trigger the replacement of the cutting tool based on the value and/or the rate of change of the value of the tool breakage indicator.

### BACKGROUND

### Field

The present disclosure relates generally to the field of cutting tool health monitoring and, more particularly, to a method for tool health monitoring which collects time series data for a machine tool signal such as spindle torque, converts the signal to the frequency domain, and computes an index which is the magnitude at the spindle frequency divided by the magnitude of a reference dataset at the spindle frequency, where an index above a defined threshold indicates cutting tool health deterioration.

### Discussion of the Related Art

It is known in the art to use computer-controlled devices to perform machining operations, such as drilling and milling, on parts. In some applications, computer numerical controlled (CNC) machines are used which move a tool along three principle directions, with or without changes in the tool's orientation. In other applications, a multi-axis industrial robot is fitted with a machining head, and the robot can move the tool along any arbitrary spatial path while also controlling the tool orientation to any desired value.

Regardless of what type of machine tool or robot is used to perform the machining operation, the quality of the finished workpiece is always important, and conditions which may be detrimental to the workpiece quality or the longevity of the machine tool must be avoided. The health of the machine tool cutting bit is a matter of particular interest, because cutting tool health deterioration can not only lead to poor workpiece finish quality, but can ultimately result in tool breakage, causing machine tool downtime and possibly requiring repairs in severe cases.

Techniques are known in the art for cutting tool health monitoring. One very basic technique is to simply keep track of the cumulative cutting work that a particular cutting tool has performed, and replacing the cutting tool after the amount of cutting work (number of cuts, total length/depth of cut, etc.) reaches a predefined threshold. This technique is simple but inaccurate, as it does not take into account the actual tool health, which may be better or worse than predicted by cutting history. Another existing technique measures actual cutting tool condition using add-on sensors which may be contact or non-contact type. This technique is more accurate than some others, but the additional sensors and the integration with the machine tool controller add cost and complexity to this type of solution.

Yet another known tool health monitoring technique measures spindle current and compares this parameter against a predefined breakage threshold. This technique is sensorless, but is not always sensitive to changes in tool health.

In view of the circumstances described above, there is a need for an improved cutting tool health monitoring method which does not require external sensors, and which can reliably detect deterioration in cutting tool health before tool breakage or part damage occur.

### SUMMARY

The present disclosure describes a method for cutting tool health monitoring which continuously evaluates the health of a cutting tool and requires no sensors to be added to the machine tool or its environment. During a machine tool cutting operation, time series data for one or more machine tool parameter such as spindle torque or servo motor velocity is collected and converted to the frequency domain. The magnitude of the data at the spindle frequency is divided by the magnitude of a reference data set for the same parameter at the spindle frequency, where the ratio is designated as a tool breakage indicator. The tool breakage indicator is monitored over time to identify any increase in value, and its value is also compared to a predefined threshold. Various criteria may be defined which trigger the replacement of the cutting tool based on the value and/or the rate of change of the value of the tool breakage indicator.

Additional features of the presently disclosed systems and methods will become apparent from the following description and appended claims, taken in conjunction with the accompanying drawings.

### BRIEF DESCRIPTION OF THE DRAWINGS

FIG. 1 is a schematic illustration of a system including a computer-controlled machine tool performing a machining operation on a workpiece, of a type applicable to the techniques of the present disclosure;

FIG. 2 is a graph of tool wear on a vertical axis versus cutting time on a horizontal axis, illustrating concepts used in development of the embodiments of the present disclosure;

FIG. 3 is an illustration of a healthy cutting tool cutting a workpiece, along with a simplified frequency response graph for the healthy cutting tool, depicting concepts used in development of the embodiments of the present disclosure;

FIG. 4 is an illustration of a damaged cutting tool cutting a workpiece, along with a simplified frequency response graph for the damaged cutting tool, depicting concepts used in development of the embodiments of the present disclosure;

FIG. 5A is a graph of spindle torque time-series data versus time leading up to a tool breakage, and FIG. 5B is a graph of a tool breakage indicator versus time, where the tool breakage indicator is calculated using the spindle torque time-series data from FIG. 5A according to an embodiment of the present disclosure; and

FIG. 6 is a flowchart diagram of a method for sensorless tool health monitoring, including calculation and analysis of a tool breakage indicator, according to an embodiment of the present disclosure.

### DETAILED DESCRIPTION OF THE EMBODIMENTS

The following discussion of the embodiments of the disclosure directed to sensorless cutting tool health monitoring is merely exemplary in nature, and is in no way intended to limit the disclosed devices and techniques or their applications or uses.

The health of the cutting tool in machine tool operations is very important, as deterioration in the health of the cutting tool can lead to workpiece quality reduction, tool breakage and even damage to the machine tool itself. The present disclosure describes a technique for continuously monitoring the health of a cutting tool using data that is readily available to the machine tool controller, without the addition of external sensors or other data acquisition equipment.

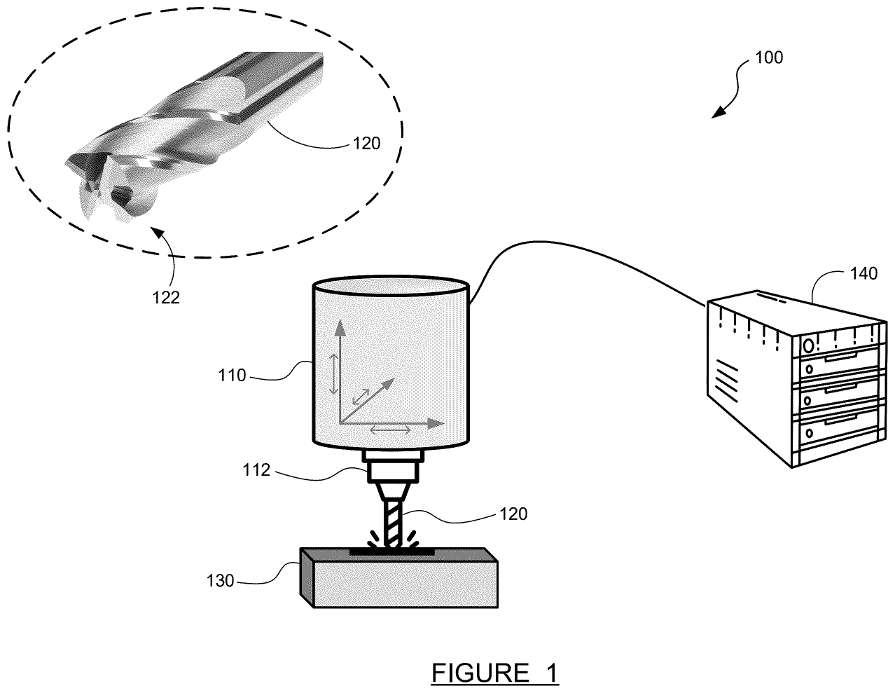

FIG. 1 is a schematic illustration of a system 100 including a computer-controlled machine tool performing a machining operation on a workpiece, of a type applicable to the techniques of the present disclosure. A machine tool 110 rotates a spindle 112 in which is secured a cutting tool, in this case an end mill 120. The machine tool 110 causes the end mill 120 to perform a machining operation on a workpiece 130. The machine tool 110 is in communication with a controller 140, which is a computing device that provides motion commands and spindle motor speed commands to the machine tool 110. In a typical example, the machine tool 110 would move the rotating end mill 120 from a start point along a path which causes material to be cut from the workpiece 130, disengage the end mill 120 from the workpiece 130 and move the end mill 120 back to a location near the start point, and then make another pass which cuts more material from the workpiece 130. The end mill 120 is shown in more detail in the inset, where the teeth or flutes are visible at a tip 122. In this example, the end mill 120 includes four teeth or flutes, also known as cutting edges.

As will be discussed in detail below, the techniques of the present disclosure are applicable to the system 100 of FIG. 1. Specifically, the presently disclosed tool health monitoring method may be programmed in the controller 140 using data that is readily available in the existing controller architecture. No sensors, microphones or other data acquisition devices are needed for data collection, and no integration of separate data acquisition or sensor sub-systems with the controller 140 is required.

The elements of FIG. 1 are depicted in rather simple fashion, where the machine tool 110 is movable in three principle axes of motion—including “vertically” (parallel to the axis of the end mill 120) and in two “horizontal” directions (orthogonal to the axis of the end mill 120). It is to be understood that the cutting tool health monitoring method of the present disclosure is applicable to any type of machine tool where cutting tool health is a matter of interest—including multi-axis machines with tool positioning and orientation capability, and robotically-controlled mills and drills with an articulated robot arm providing complete tool positioning and orientation flexibility.

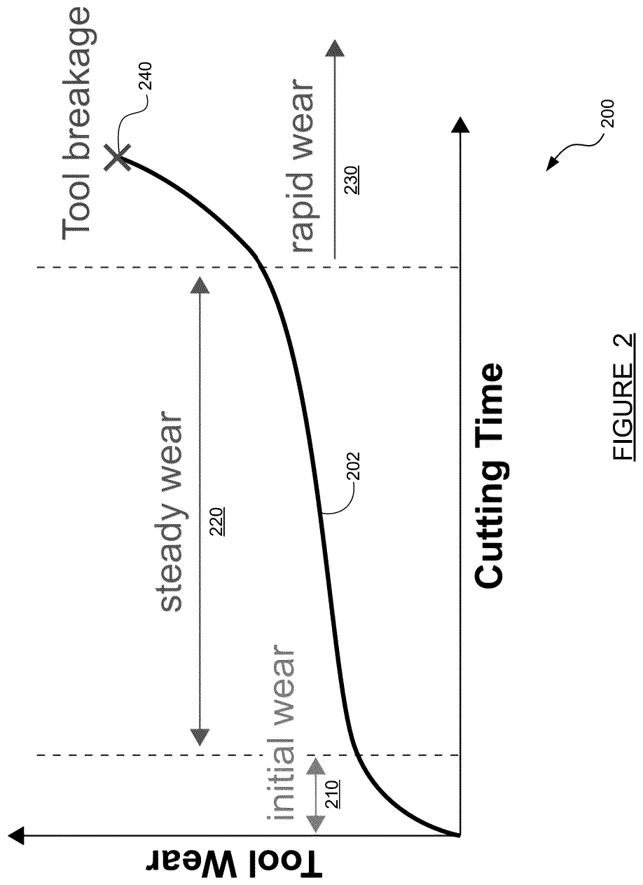

FIG. 2 is a graph 200 of tool wear on a vertical axis versus cutting time on a horizontal axis, illustrating concepts used in development of the embodiments of the present disclosure. The graph 200 illustrates a typical lifecycle of a cutting tool, where a curve 202 plots the tool wear—which is intended to represent an actual amount of physical wear which would be found by stopping the machining operation and measuring the cutting tool—particularly the condition of the cutting edges.

When a new cutting tool is installed in a machine tool, the cutting tool will first experience an initial wear phase, indicated by double arrow 210 in FIG. 2. During the initial wear phase, the very sharp tips of the cutting edges will be worn down fairly rapidly but only slightly, as indicated by the initial shape of the curve 202. During a steady wear phase, indicated by a double arrow 220, the cutting edges of the machine tool will wear quite slowly and fairly steadily. During the steady wear phase, machine tool performance is predictable and workpiece finish quality is good. By the end of the steady wear phase, the cutting edges have worn down to an extent where they are no longer cutting workpiece material as efficiently, which causes higher tool-workpiece impact forces during cutting. The higher impact forces lead in turn to more rapid wear. During a rapid wear phase, indicated by an arrow 230, tool wear increases rapidly, feeding upon itself, until tool breakage occurs at a point 240.

The duration of the steady wear phase may vary considerably from one cutting tool to another. Because of this, there is no accurate and reliable way to predict when a tool will break based only upon cutting workload. Techniques which attempt to do this must err on the side of caution and call for tool replacement based on the shortest known duration of the steady wear phase. This means that cutting tools will be replaced which still have a significant amount of good, useful life remaining.

The techniques of the present disclosure have been developed—based on insights into tool wear phenomena and how they may be detected—to recognize when a cutting tool has entered the rapid wear phase, and to call for tool replacement during the end stages of a tool's life but before tool breakage occurs.

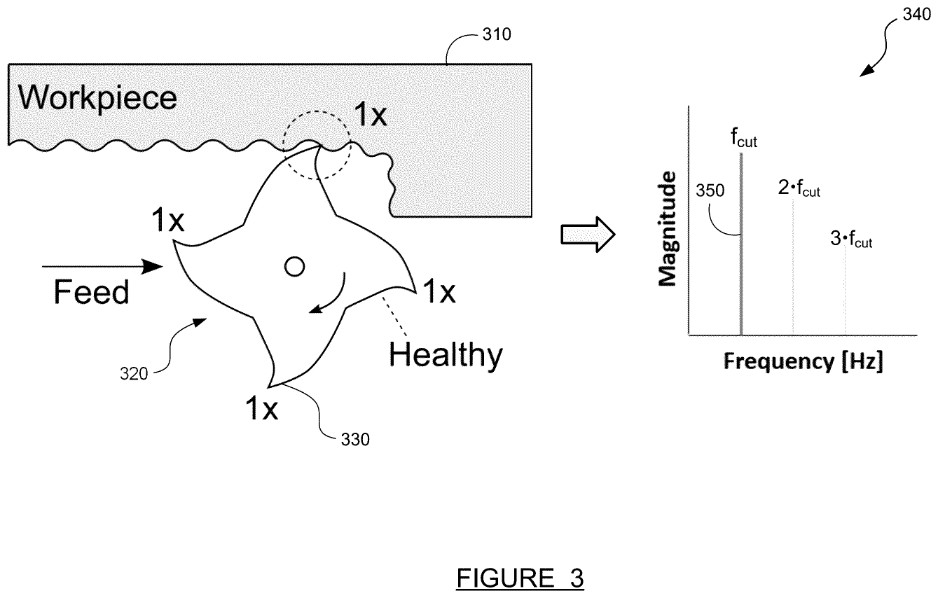

FIG. 3 is an illustration of a healthy cutting tool cutting a workpiece, along with a simplified frequency response graph for the healthy cutting tool, depicting concepts used in development of the embodiments of the present disclosure. In FIG. 3, a workpiece 310 is being machined by a cutting tool 320. The cutting tool 320 is rotating as indicated by the curved arrow, and the cutting tool is moving in a direction indicated by the Feed arrow. The cutting tool 320, which corresponds with the end mill 120 of FIG. 1, has four cutting edges 330 (also known as teeth or flutes). All four cutting edges 330 are in good cutting condition, which corresponds with the initial wear and steady wear phases of FIG. 2.

In the situation shown in FIG. 3, each of the four cutting edges 330 cuts material from the workpiece 310, and for a given feed speed and depth of cut, the amount of material cut by each of the cutting edges 330 is essentially the same. This is indicated by the “1×” at the tip of each of the cutting edges 330, which means that each of the cutting edges 330 cuts the same amount of material. Each time the tip of one of the cutting edges 330 makes contact with the workpiece 310, there is an impact force upon the cutting tool 320 and the workpiece 310, and also a torque applied to the cutting tool 320 which tries to slow down the rotation of the cutting tool 320.

The forces and torques described above create mechanical vibrations in the machine tool and noise in the surrounding environment. If the mechanical vibrations or the ambient noise is analyzed, the frequency spectrum will appear generally as shown in a graph 340 at the right of FIG. 3. In particular the frequency response graph will have a dominant peak at the cutting frequency f_{cut}, which is defined as the spindle frequency (f_{spindle}) multiplied by the number of cutting edges, which is four in this case. For example, if the spindle speed (rotational velocity) is 7200 rpm, this is equal to 120 Hz (revs/second), so the cutting frequency f_{cut} is 120*4=480 Hz. In the graph 340, the dominant peak in the frequency response is indicated by line 350. Significant peaks in the frequency response are also seen at the harmonics of f_{cut} (2×, 3×, etc.), as shown in the graph 340. In a frequency response graph using actual data, there would be many small spikes at many different frequency, as would be understood by those skilled in the art. Still, the major spikes in the response magnitude at f_{cut} and its harmonics would be dominant.

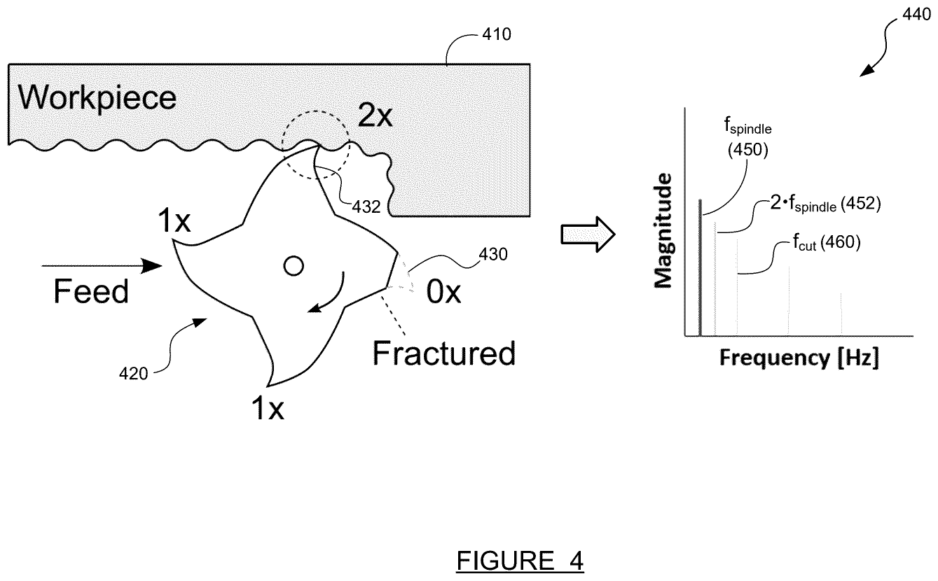

FIG. 4 is an illustration of a damaged cutting tool cutting a workpiece, along with a simplified frequency response graph for the damaged cutting tool, depicting concepts used in development of the embodiments of the present disclosure. In FIG. 4, a workpiece 410 is being machined by a cutting tool 420, in the same manner as discussed above for FIG. 3. The cutting tool 420 has four cutting edges; however, one of the cutting edges (labeled as 430) has fractured and is missing its tip. When one cutting edge becomes damaged as shown in FIG. 4, unequal cutting loads are felt on the other teeth; this corresponds with the rapid wear phase of FIG. 2.

In the situation shown in FIG. 4, the cutting edge 430 does not contact the workpiece 410 and therefore does not cut any material. This is indicated by the “0×” at the tip of the cutting edge 430. This means that the next cutting edge to encounter the workpiece 410 will have to cut a disproportionately large amount of material. The next cutting edge is a cutting edge 432 (based on the direction of rotation of the cutting tool 420), and the “2×” near its tip indicates that it has to cut approximately twice as much material from the workpiece 410 as a result of the cutting edge 430 not cutting any material. In this situation, impact force and the counter-rotational torque on the cutting tool 420 will be much larger for the cutting edge 432 than the other two undamaged cutting edges.

For the damaged cutting tool 420 of FIG. 4, if the mechanical vibrations or the ambient noise is analyzed, the frequency response spectrum will appear generally as shown in a graph 440 at the right of FIG. 4. In particular the frequency response graph will have a significant peak at the spindle frequency (f_{spindle}), which is lower than the cutting frequency f_{cut} by a factor of four in this case, as discussed above. The reason that the significant peak in the frequency response graph 440 is at the spindle frequency is because of the large impact when the cutting edge 432 strikes the workpiece 410, which occurs once per revolution of the cutting tool 420 (i.e., it occurs at the spindle frequency f_{spindle}). In contrast, in FIG. 3, each cutting edge experienced approximately the same impact force, and so the dominant peak in the frequency response was at the frequency of cutting edge impact (f_{cut}). In the graph 440, the dominant peak in the frequency response is indicated by line 450 at f_{spindle}. Significant peaks in the frequency response are also seen at the harmonics of f_{spindle} (a 2× harmonic is indicated by line 452 on the graph 440), and frequency response peaks are also visible at the cutting frequency (f_{cut}—indicated by line 460) and its harmonics.

It has been observed in real-world machine tool operations that the onset of significant tool degradation (entry into the rapid wear phase) often begins with chipping or fracturing of one cutting edge (tooth) of the cutting tool, as shown in FIG. 4. Thus, the sensorless tool health monitoring method of the present disclosure is based on tracking the magnitude of the frequency response of one or more machine tool parameters at the spindle frequency.

According to the disclosed technique, a tool breakage indicator is defined as follows:

$$TBI = \frac{\vert X ( {f}_{spindle} ) \vert}{\vert {X}_{ref} ( {f}_{spindle} ) \vert} \qquad ( 1 )$$

Where X is a current sample of any suitable signal (discussed below) in the frequency domain, and f_{spindle} is the spindle frequency in Hz. Thus, the numerator of Equation (1) is the magnitude of the frequency response of X at the spindle frequency. X_{ref} is the frequency response of a reference copy of the same signal stored when the cutting tool was new. Thus, the denominator of Equation (1) is the magnitude of the frequency response of X_{ref} at the spindle frequency.

When a cutting tool is new, the frequency response at the spindle frequency will be low (essentially the same as X_{ref}), because there will be no damaged cutting teeth. Thus, for a new tool, the value of the tool breakage indicator will be around one (TBI≈1). As tool wear progresses and the cutting tips begin to exhibit different amounts of wear and chipping, the impact forces at the spindle speed also increase, and the value of |X(f_{spindle})| becomes larger. Thus, the tool breakage indicator of Equation (1) increases as tool wear progresses.

Research into sensorless tool health monitoring has revealed that the best results—that is, the clearest indication of tool deterioration—are obtained by measuring and analyzing the frequency response only at the spindle frequency, and not also including higher harmonic frequencies. This is because the data at the higher harmonic frequencies exhibits problems with signal sensitivity and noise, which makes the analysis of the results less definitive.

It was explained above that X is a current sample of any suitable signal in the frequency domain. In preferred embodiments, parameter data available in the machine controller is used for X. For example, for a 3-axis mill as discussed with respect to FIG. 1, time-series pulsecoder (angular position) data for the X, Y and Z servo motors may be differentiated to obtain servo angular velocity, and the time-series velocity data converted to the frequency domain (such as by FFT). Spindle rotational time-series data may also be converted to the frequency domain and used for X, including spindle velocity (from the machine controller), spindle torque command (computed by the controller), or spindle motor current (as an indicator of torque). Measured vibration or sound data in the frequency domain may also be used for X.

In some embodiments, only a single data parameter, such as spindle torque, may be used to compute the tool breakage indicator. In this case, X is spindle torque command data (for example), converted from time-series to the frequency domain. In another embodiment, pulsecoder data for all three servo motors (differentiated to obtain velocity, and converted to the frequency domain) is used along with spindle torque data in a composite tool breakage indicator computed as follows:

$$TBI = \sqrt{{TBI}_{X}^{2} + {TBI}_{Y}^{2} + {TBI}_{Z}^{2} + {TBI}_{S}^{2}} / \sqrt{4} \qquad ( 2 )$$

Where TBI_{X}, TBI_{Y}, and TBI_{Z} are the tool breakage indicators for the X, Y and Z servos, and TBI_{S} is the tool breakage indicator for the spindle (torque or velocity), all computed using Equation (1) as discussed above. The composite tool breakage indicator of Equation (2) uses four individual tool breakage indicators in a square-root-of-the-sum-of-the-squares calculation, divided by the square root of the number of terms. Thus, for a new tool where each of the individual tool breakage indicators is approximately equal to one, the composite tool breakage indicator computed by Equation (2) also has a value TBI≈1. Note that TBI does not need to be formulated as in Equation (2) exactly. For example, TBI may also be calculated as a weighted average of TBI_{X}, TBI_{Y}, TBI_{Z}, and TBI_{S}.

It should be understood that any individual parameter (e.g., just the X servo motor pulsecoder data) may be used to calculate a tool breakage indicator using Equation (1), or any combination of parameters (e.g., the Y servo motor pulsecoder data and the spindle torque data) may be used to calculate a composite tool breakage indicator using Equations (1) and (2). Equation (2) as shown above, which uses all three servo motors' pulsecoder data and spindle torque data, is just one specific example. Composite tool breakage indicators using other calculations may also be computed, as also noted above.

In preferred embodiments, the tool breakage indicator TBI is calculated on an ongoing basis and monitored in real time during machining operations; for example, the tool breakage indicator may be calculated every 100 milliseconds (ms) and the value evaluated. For each new calculation of TBI, a current sample of data for X is taken and used; for example, the servo motor and spindle motor time-series data described above may be collected and converted to the frequency domain, then used in Equation (1) to calculate a tool breakage indicator for each individual parameter. Calculation of a composite tool breakage indicator from multiple individual tool breakage indicators may be performed using Equation (2). All of the data collection and analysis may be performed by the machine controller.

As described above, machine tool parameter data is collected and one or more tool breakage indicators are computed by the machine controller in real time on a periodic basis. The tool breakage indicator values are then analyzed to evaluate tool health, and alerts may be issued when warranted by tool breakage indicator values. The alerts may include any combination of audible alarms, visual alerts, notification messages sent to machine operators, etc. One example of an alert would be a warning issued when the tool breakage indicator has an elevated but not critically high value, such as being greater than 3.0 for three seconds. Another example of an alert would be an urgent warning, possibly accompanied by automatic tool stoppage, when the tool breakage indicator has a critically high value such as greater than 5.0 in any computation cycle. A sensorless tool health monitoring algorithm may also be programmed to evaluate individual tool breakage indicators along with a composite tool breakage indicator.

The tool breakage indicator calculations described above and used in a sensorless tool health monitoring system provide several advantages over prior art techniques. One significant advantage of the presently disclosed technique is that the tool breakage indicator can clearly and accurately detect tool health deterioration when analysis of time series data cannot.

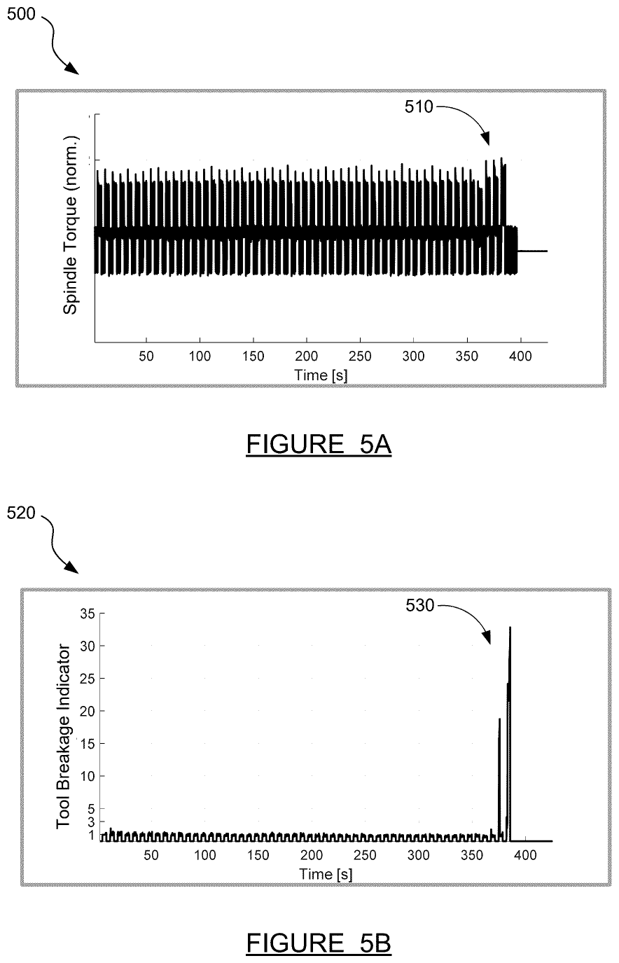

FIG. 5A is a graph 500 of spindle torque time-series data versus time leading up to a tool breakage, and FIG. 5B is a graph 520 of a tool breakage indicator versus time, where the tool breakage indicator is calculated using the spindle torque time-series data from FIG. 5A according to an embodiment of the present disclosure.

In the graph 500, spindle torque is plotted versus time for a machining operation lasting several minutes. The spindle torque is time-series data which is normalized, such as a percentage of maximum spindle torque, and thus the units on the vertical axis are not important. The machining operation ended in tool breakage. However, the time-series torque data shows very little noticeable change in the last few seconds of the machining operation, in the part of the graph indicated by arrow 510. The subtle changes in the graph 500 make it difficult or impossible to detect tool breakage, let alone identify tool health deterioration before tool breakage, using time-series torque data.

In the graph 520, a tool breakage indicator is plotted versus time for the same machining operation as in FIG. 5A. Specifically, the tool breakage indicator plotted in the graph 520 was computed from the time-series spindle torque data of FIG. 5A. It can be seen in FIG. 5B that the tool breakage indicator goes along steadily, having a value of around 1.0 for most of the machining operation. However, near the end of the machining operation, the tool breakage indicator jumps to much higher values as the tool becomes significantly damaged and then breaks. The sudden increases in the tool breakage indicator are clearly evident in the last few seconds of the machining operation, in the part of the graph indicated by arrow 530. The first sudden increase in the tool breakage indicator would enable the machine controller to stop the machining operation (i.e., stop the feed of the cutting tool and turn off the spindle motor), thereby possibly preventing the ultimate cutting tool breakage event and possibly avoiding damage to the machine tool or even a dangerous shrapnel situation.

Although existing tool health monitoring systems which use time-series torque data can detect tool deterioration or breakage in some instances, FIGS. 5A and 5B clearly demonstrate that the tool breakage indicator of the present disclosure can detect tool deterioration and breakage in situations where time-series-based methods cannot.

The sensorless tool health monitoring system of the present disclosure also provides other advantages over prior art techniques. One such advantage is that the tool breakage indicator calculated as per Equation (1) evaluates the frequency response magnitude at the spindle frequency f_{spindle}. Because f_{spindle} is a much lower frequency than f_{cut} and its harmonics, and those higher frequencies are not analyzed in the presently disclosed technique, data sampling speeds may be reduced without loss of accuracy. Lower data sampling speeds enable the calculations of the present disclosure to be performed with less computing resources (CPU power, memory and storage) required of the machine controller.

The sensorless tool health monitoring system of the present disclosure, using the tool breakage indicator, has also been demonstrated to be effective in monitoring the health of small tools—such as cutting tools having a diameter in a range of about 1.5 mm to 3 mm. Because cutting loads (therefore spindle torque values) with small tools are so low, monitoring tool health using time-series torque data does not reliably detect tool defects—with experimental data showing almost no change in normalized torque with damaged tools versus new tools. In contrast, experiments showed that the tool breakage indicator increases noticeably from a new tool to a lightly damaged tool, and further increases from the lightly damaged tool to a more significantly damaged tool. Like the results discussed above with respect to FIG. 5, the results with small tools indicate the effectiveness of the tool breakage indicator calculated at the spindle frequency f_{spindle}.

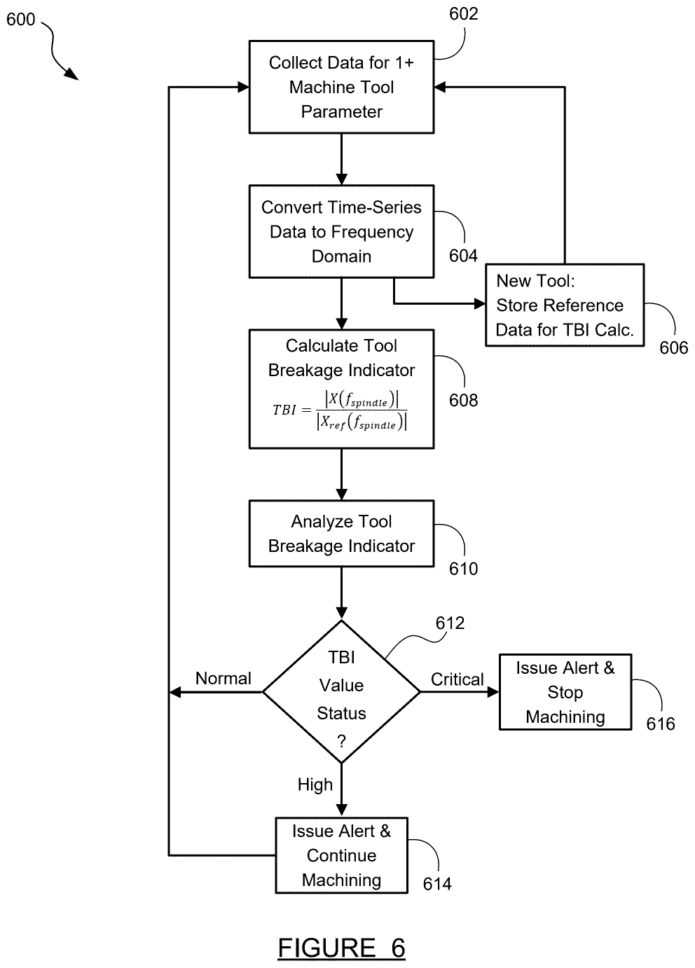

FIG. 6 is a flowchart diagram 600 of a method for sensorless tool health monitoring, including calculation and analysis of a tool breakage indicator, according to an embodiment of the present disclosure. The method of FIG. 6 is performed during machining operations on a machine tool, and in preferred embodiments is performed by an algorithm running on a machine controller which is in communication with the machine tool. The method could also be performed by another computing device which receives data from the machine controller or measures other parameter data as discussed above.

At box 602, data for one or more machine tool parameters is collected. In preferred embodiments, the data is time-series data which is available and known to the machine controller—such as spindle torque or velocity (measured or calculated/inferred), and/or servo motor position or velocity data. The data measured at the box 602 may also include sound data recorded in the machine tool environment, or mechanical vibration data measured by an accelerometer mounted on or proximal to the machine tool, for example. The data sample(s) recorded at the box 602 preferably have a defined time duration, such as 50 or 100 milliseconds (ms). Any suitable time duration of data collection may be used.

At box 604, the time-series data is converted to the frequency domain, such as by running a Fast Fourier Transform calculation. Converting a sample of time-series data to the frequency domain to create a frequency response spectrum is known in the art. If the data collected at the box 602 is already in the frequency domain, such as sound or vibration data recorded by a frequency spectrometer, then the box 604 is bypassed. At box 606, in a first machining operation after a new tool is installed, the frequency response data for the data sample(s) is stored as reference data for future use in calculating the tool breakage indicator. The time-series data for a new tool may be stored for reference, and/or the frequency response data may be stored. Ultimately, however, all that needs to be stored for reference is the magnitude of the frequency response at the spindle frequency f_{spindle}. This is the denominator (|X_{ref}(f_{spindle})|) of Equation (1). If more than one machine tool parameter (e.g., all three servos plus the spindle) is being recorded and analyzed, then reference data is stored for each of the parameters.

At box 608, a tool breakage indicator TBI is calculated for the one or more parameters for which data are collected. The tool breakage indicator is calculated using Equation (1), as discussed earlier. If more than one machine tool parameter (e.g., all three servos plus the spindle) is being recorded and analyzed, then the tool breakage indicator for each parameter is calculated at the box 608, and a composite tool breakage indicator may also be calculated from the individual tool breakage indicators using Equation (2), as discussed earlier. The tool breakage indicator calculations at the box 608 use the current data for each parameter (magnitude of the frequency response at the spindle frequency; i.e., |X(f_{spindle})|) along with the stored reference data for the parameter (|X_{ref}(f_{spindle})|).

At box 610, the tool breakage indicator value(s) are analyzed according to any desired criteria. For example, if only one machine tool parameter is measured (such as spindle torque), the calculated value of the tool breakage indicator may be compared to first and second threshold values, where the first threshold may trigger an alert while allowing the machining operation to continue, and the second (higher) threshold may trigger a critical alert and also command a shutdown of the machine tool. Tool breakage indicator trends may also be analyzed at the box 610, such as a rate of change of the tool breakage indicator value and/or the tool breakage indicator value being over a third (lower) threshold value for a certain period of time. If more than one machine tool parameter is measured, the tool breakage indicators for each parameter are evaluated at the box 610, and a composite tool breakage indicator may also be calculated and evaluated. Each individual tool breakage indicator and the composite tool breakage indicator may have different criteria for triggering an alert or action, as found to be suitable by the machine tool operator.

At decision diamond 612, the process branches to a next step which is dependent upon the status of the tool breakage indicator analysis. If the tool breakage indicator (or multiple tool breakage indicators) are found to be normal at the box 610, then from the decision diamond 612 the process loops back to the box 602 to take another data sample. The looping back from the decision diamond 612 to the box 602 may be programmed to occur on a periodic time basis, such as 100 ms or 500 ms, for example.

If the tool breakage indicator(s) are found to be above normal but not critically high at the box 610, then from the decision diamond 612 the process moves to box 614 where an alert is issued and then the process loops back to the box 602 to take another data sample. The alert issued at the box 614 is designed to get the attention of a machine operator, indicating that tool health may be deteriorating and further investigation and action may be required. The alert may be an audible alarm, a visual signal, an electronic message to a computer, controller or mobile device, or a combination of these alert types.

If the tool breakage indicator(s) are found to be critically high at the box 610, then from the decision diamond 612 the process moves to box 616 where an alert is issued and the machining operation is paused. The critical alert and machine stoppage actions at the box 616 are taken when the tool breakage indicator indicates a severely damaged tool where breakage may be imminent. The actions taken at the boxes 614 and 616 are merely exemplary; machine tool operators may choose to design the analysis criteria of the box 610 and the resulting actions in any manner deemed suitable to the business. In all cases, the calculation of the tool breakage indicator(s) using the disclosed techniques provides insight into tool health and deterioration which are not available with existing methods.

Throughout the preceding discussion, various computers and controllers are described and implied. It is to be understood that the software applications and modules of these computers and controllers are executed on one or more electronic computing devices having a processor and a memory module. In particular, this includes the machine controller 140 of FIG. 1 which was discussed earlier. Specifically, the processor in the controller 140 is configured to perform the sensorless tool health monitoring described above, including the method steps of FIG. 6, and the calculations using the equations and other techniques described above, along with the control of the machine tool itself. Some or all of the sensorless tool health monitoring may also be performed by a separate computing device in communication with the machine controller, as mentioned earlier.

While a number of exemplary aspects and embodiments of the method for sensorless tool health monitoring have been discussed above, those of skill in the art will recognize modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method for sensorless tool health monitoring, said method comprising:
collecting data, by a machine controller, for a machine tool parameter during machining operations;
converting the data to a frequency domain to produce a frequency response spectrum;
calculating a tool breakage indicator as a magnitude of the frequency response spectrum at a spindle frequency divided by a magnitude of a reference frequency response spectrum at the spindle frequency;
comparing the tool breakage indicator to one or more predefined threshold values; and
taking remedial action, by the machine controller, when the tool breakage indicator exceeds one or more of the predefined threshold values.

2. The method according to claim 1 wherein the machine tool parameter is spindle torque command data, or the machine tool parameter is a tool positioning servo motor position data which is differentiated to produce servo velocity data before converting to the frequency domain.

3. The method according to claim 1 wherein the data for the machine tool parameter is collected for a predefined time period, and collecting the data and calculating the tool breakage indicator is repeated periodically during the machining operation.

4. The method according to claim 1 wherein the spindle frequency is equal to a spindle rotational velocity in revolutions per second.

5. The method according to claim 1 wherein the reference frequency response spectrum was produced from a reference dataset for the machine tool parameter during the machining operation when a cutting tool was new.

6. The method according to claim 1 wherein the tool breakage indicator indicates a health of a cutting tool, where a higher value of the tool breakage indicator indicates a poorer health of the cutting tool, and at least one of the predefined threshold values is in a range of 1.5-3.0.

7. The method according to claim 1 further comprising collecting data for at least one other machine tool parameter during the machining operation, calculating the tool breakage indicator for the at least one other machine tool parameter, comparing the tool breakage indicator for the at least one other machine tool parameter to one or more other predefined threshold values, and taking remedial action when any of the tool breakage indicators exceeds any of its associated threshold values.

8. The method according to claim 7 wherein individual tool breakage indicators are calculated for spindle torque command data and position data for at least one tool positioning servo motor, where the position data is differentiated to produce velocity data before converting to the frequency domain.

9. The method according to claim 8 further comprising computing a composite tool breakage indicator using a square-root-of-the-sum-of-the-squares calculation including each of the individual tool breakage indicators, and taking remedial action when the composite tool breakage indicator exceeds an associated threshold value.

10. The method according to claim 1 wherein the remedial action includes issuing an alert when any of the threshold values is exceeded, and stopping the machining operation when a highest of the threshold values is exceeded.

11. A method for sensorless tool health monitoring, said method comprising:
collecting data, by a machine controller, for a plurality of machine tool parameters during machining operations;
converting the data to a frequency domain to produce a frequency response spectrum for each of the parameters;
calculating a tool breakage indicator, for each of the parameters, as a magnitude of the frequency response spectrum at a spindle frequency divided by a magnitude of a reference frequency response spectrum at the spindle frequency, where the reference frequency response spectrum was produced from a reference dataset for the parameter during the machining operation when a cutting tool was new;
comparing the tool breakage indicators to one or more predefined threshold values; and
taking remedial action, by the machine controller, when any of the tool breakage indicator exceeds any of the predefined threshold values.

12. The method according to claim 11 wherein the plurality of machine tool parameters includes spindle torque command data and position data for at least one tool positioning servo motor, where the position data is differentiated to produce velocity data before converting to the frequency domain.

13. The method according to claim 12 further comprising computing a composite tool breakage indicator using a square-root-of-the-sum-of-the-squares calculation including each of the tool breakage indicators, and taking remedial action when the composite tool breakage indicator exceeds an associated threshold value.

14. A sensorless machine tool health monitoring system, said system comprising:
a machine tool configured for performing an operation on a workpiece; and
a computing device in communication with the machine tool, said computing device being configured to monitoring health of a cutting tool by performing steps including;
collecting data for a machine tool parameter during the operation;
converting the data to a frequency domain to produce a frequency response spectrum;
calculating a tool breakage indicator as a magnitude of the frequency response spectrum at a spindle frequency divided by a magnitude of a reference frequency response spectrum at the spindle frequency;
comparing the tool breakage indicator to one or more predefined threshold values; and
taking remedial action, including issuing an alert or stopping the operation by the machine tool, when the tool breakage indicator exceeds one or more of the predefined threshold values.

15. The system according to claim 14 wherein the machine tool parameter is spindle torque command data, or the machine tool parameter is a tool positioning servo motor position data which is differentiated to produce servo velocity data before converting to the frequency domain.

16. The system according to claim 14 wherein the data for the machine tool parameter is collected for a predefined time period, and collecting the data and calculating the tool breakage indicator is repeated periodically during the operation.

17. The system according to claim 14 wherein the reference frequency response spectrum was produced from a reference dataset for the machine tool parameter during the operation when the cutting tool was new.

18. The system according to claim 14 further comprising collecting data for at least one other machine tool parameter during the operation, calculating the tool breakage indicator for the at least one other machine tool parameter, comparing the tool breakage indicator for the at least one other machine tool parameter to one or more other predefined threshold values, and taking remedial action when any of the tool breakage indicators exceeds any of its associated threshold values.

19. The system according to claim 18 wherein individual tool breakage indicators are calculated for spindle torque command data and position data for at least one tool positioning servo motor, where the position data is differentiated to produce velocity data before converting to the frequency domain.

20. The system according to claim 19 further comprising computing a composite tool breakage indicator using a square-root-of-the-sum-of-the-squares calculation including each of the individual tool breakage indicators, and taking remedial action when the composite tool breakage indicator exceeds an associated threshold value.
